(19) United States
(12) Patent Application Publication
(10) Pub. No.: US 2009/0055538 A1
(43) Pub. Date: Feb. 26, 2009

(54) Content commentary

(75) Inventors: Jonathan L. Conradt, San Jose, CA (US); Sharon F. Barnett, Belmont, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/894,446

(22) Filed: Aug. 21, 2007

(51) Int. Cl. G06F 15/16

(52) U.S. Cl. 709/227

(57) ABSTRACT

Techniques involving content commentaries are described. In an implementation, a commentary is made at a client during output of content. The commentary is to be output concurrently with a subsequent output of the content. A communication is formed that includes the commentary to be communicated over a network such that the commentary is available to be output at another client.

### BACKGROUND

Commentaries may be provided for a variety of different purposes. For example, a sporting event may use an announcer that comments on the action of the game, an awards show may include a reporter on a “red carpet” to comment on celebrities as they arrive, and so on. However, in each of these instances the commentary is an integral part of the content itself. In other words, the content is the commentary about the event. In some instances, however, it may be desirable to interact with a different commentary.

Because the commentary was an integral part of the content itself, however, the user was forced to navigate between content to locate particular content having a desired commentary. For example, a user may view coverage of the awards show as previously described on a particular channel. To view another commentary of the same awards show, the user was forced to navigate to another channel. Further, use of these traditional techniques limited the user's choice of commentaries to the particular content, which is inefficient and limiting especially considering the ever increasing variety of ways in which users communicate.

### SUMMARY

Techniques involving content commentaries are described. In an implementation, a commentary is made at a client during output of content. The commentary is to be output concurrently with a subsequent output of the content. A communication is formed that includes the commentary to be communicated over a network such that the commentary is available to be output at another client.

In another implementation, a system is described that includes one or more modules to collect a plurality of commentaries via a network regarding a plurality of content. The plurality of commentaries is provided for distribution over a network connection to one or more clients.

In a further implementation, a client includes one or more modules that are executable to select one of a plurality of commentaries over a network connection to be output concurrently with content that includes video. The selected commentary is configured to be streamed in parallel separately from the content.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ content commentary techniques.

FIG. 2 is an illustration of a system in an exemplary implementation showing a plurality of clients and a commentary provider of FIG. 1 in greater detail.

FIG. 3 is an illustration depicting an exemplary user interface as output by a client to search for one or more of a plurality of commentaries from the commentary provider of FIG. 2.

FIG. 4 is a flow diagram depicting a procedure in an exemplary implementation in which a commentary is made by a client and made available to another client to output in conjunction with content.

FIG. 5 is a flow diagram depicting a procedure in an exemplary implementation in which the commentary service of FIG. 1 collects commentaries and provides the commentaries for distribution over a network to the clients of FIG. 1.

FIG. 6 is a flow diagram depicting a procedure in an exemplary implementation in which a commentary is purchased and output in conjunction with content.

### DETAILED DESCRIPTION

Overview

Users have access to a wide range of content, such as television programming, movies, music, and so on. In some instances, a user may wish for an outside perspective on the content that is apart from content itself. For example, an awards show may have a reporter that describes what is happening during the show. In this example, however, the commentary is an integral part of the content itself and consequently is not able to be separated from the content. Accordingly, if the user wishes to gain a different perspective offered by a different commentary, the user is forced to access content having the desired commentary. Thus, the user may be forced to navigate between a variety of different content to locate particular commentary of interest. Consequently, these traditional commentaries may be considered the content itself. In other words, these traditional commentaries are not commenting on the content itself but rather are the content.

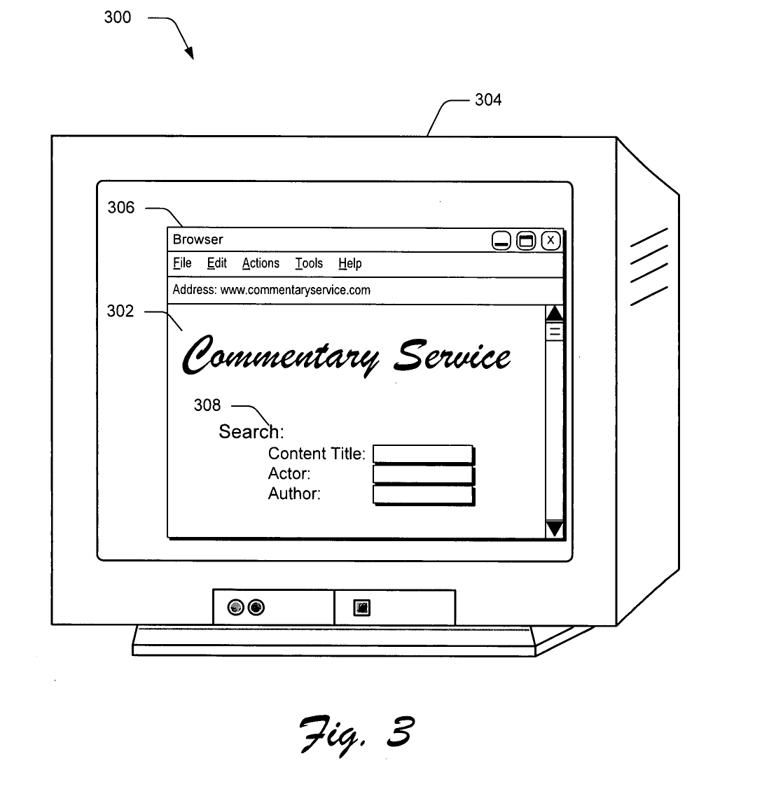

Techniques are described to form a commentary to be output in conjunction with content. A user, for example, may download a module that accepts an input provided by a user to form a commentary. The input may be configured in a variety of ways, such as text, audio input, video input, and so on. The commentary may then be configured for output in conjunction with content by another user such that the user may experience the commentary. Additionally, the commentary may be configured as separate from the content, thereby enabling output of the commentary as desired without interfering with the content. Further discussion of commentary formation may be found in relation to FIG. 3.

Techniques are also described to make a plurality of commentaries available via a network connection. For example, a web site may be configured to collect commentaries from a plurality of clients, such as from traditional “home users”. These commentaries may then be made available to users to be output in conjunction with content as desired. For instance, the users may utilize search functionality to locate commentaries, pick commentaries based on ratings (e.g., “star” ratings), popularity, and so on. A chosen commentary may then be communicated to the client for output in conjunction with desired content.

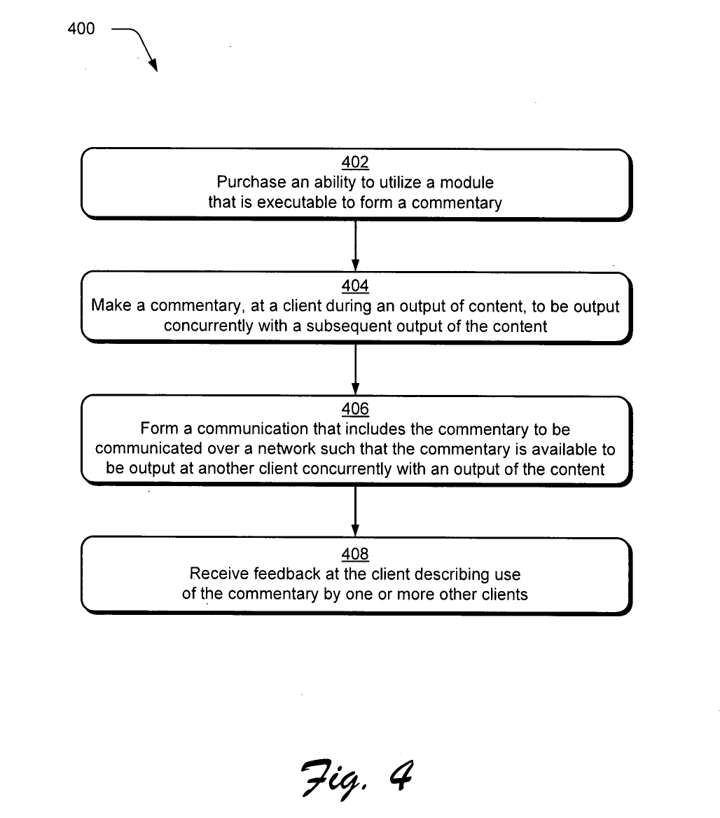

Additionally, revenue may also be collected by a provider of the website, such as for advertisements, based on fees collected from users of the website (e.g., pay per use, subscription based), and so forth. A variety of other instances are also contemplated, further discussion of which may be found in relation to FIGS. 4-6.

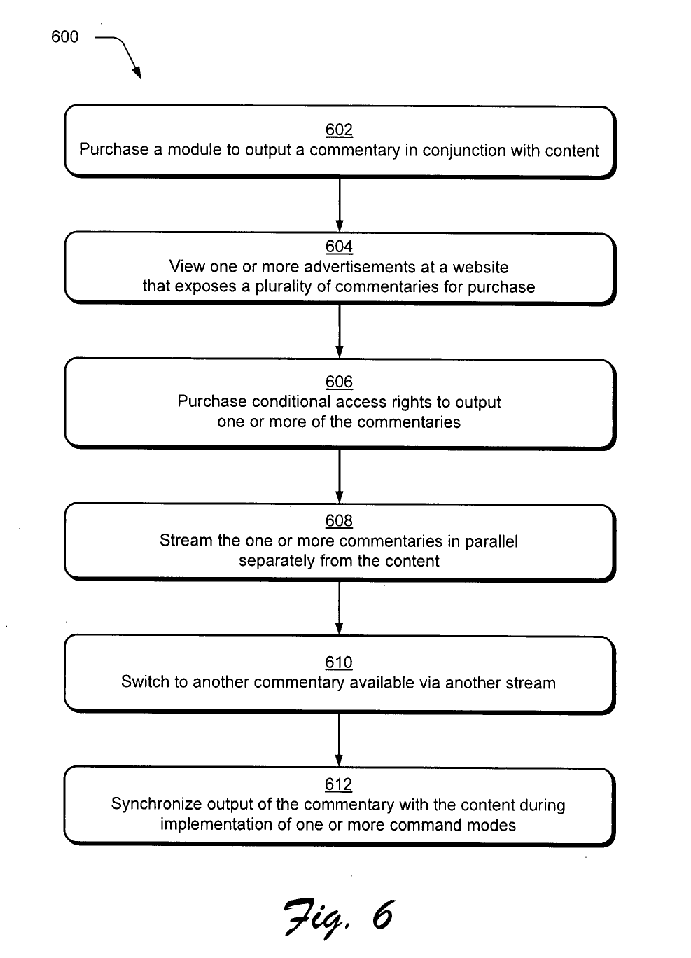

Techniques are further described to consume commentaries. Continuing with the previous example, a user may locate a particular commentary of interest. The particular commentary of interest may then be communicated for output with the content, such as a stream in a transport stream that is also used to communicate the content. In an implementation, the user may also switch between streams during output of the content to access different commentaries. Further discussion of output of commentaries may be found in relation to FIG. 6.

Exemplary Environment

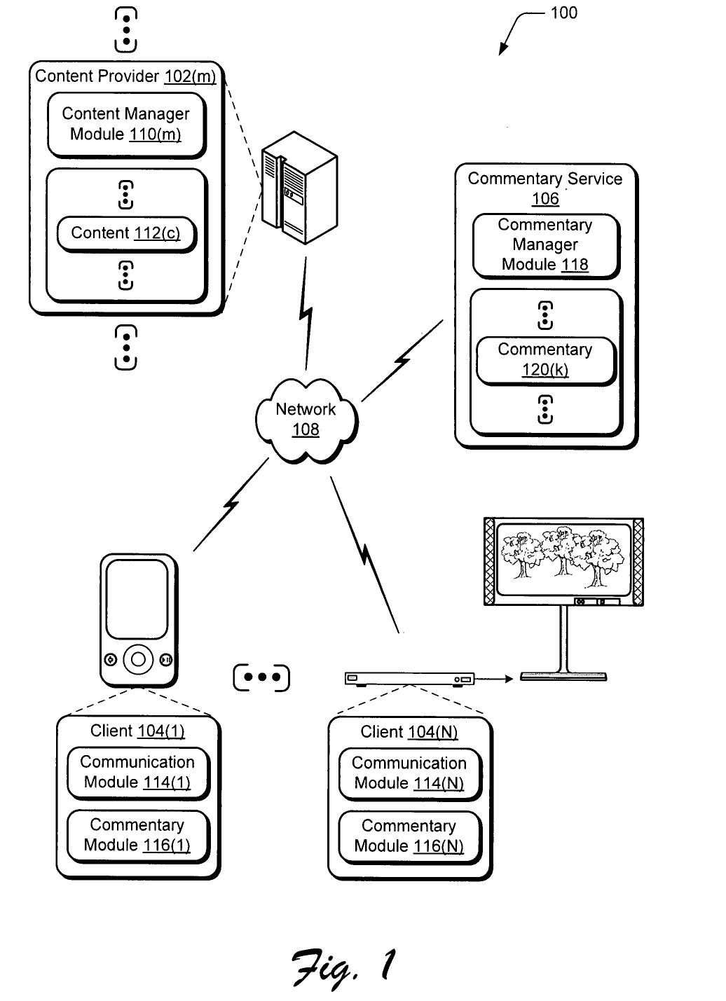

FIG. 1 is an illustration of an environment 100 in an exemplary implementation that is operable to employ content commentary techniques. The illustrated environment 100 includes a plurality of providers 102(m) (where “m” can be any integer from one to “M”), a plurality of clients 104(1)-104(N) and a commentary service 106, each of which are communicatively coupled, one to another, over a network 108.

The clients 104(1)-104(N) may be configured in a variety of ways. For example, the clients may be configured as a computer that is capable of communicating over the network 108, such as a desktop computer, a mobile station, an entertainment appliance, a wireless phone, a portable music player (e.g., as illustrated by client 104(1)), a set-top box communicatively coupled to a display device (e.g., as illustrated by client 104(N)), a game console, and so forth. Thus, the clients 104(1)-104(N) may range from full resource devices with substantial memory and processor resources (e.g., personal computers, game consoles) to a low-resource device with limited memory and/or processing resources (e.g., traditional set-top boxes, hand-held game consoles). The clients 104(1)-104(N) may also relate to a person and/or entity that operate the clients. In other words, clients 104(1)-104(N) may describe logical clients that include users, software and/or devices.

Although the network 108 is illustrated as the Internet, the network 108 may assume a wide variety of configurations. For example, the network 108 may include a wide area network (WAN), a local area network (LAN), a wireless network, a public telephone network, an intranet, a wireless broadcast network with backchannel communication, a cable television network, and so on. Further, although a single network 108 is shown, the network 108 may be configured to include multiple networks. For instance, the clients 104(1)-104(N) may be communicatively coupled via a cable television network with backchannel communication to communicate with the content provider 102(m). Additionally, the clients 104(1)-104(N) may be communicatively coupled via the Internet to communicate with the commentary service 106. A wide variety of other instances are also contemplated.

The content provider 102(m) is illustrated as including a content manager module 110(m) which is illustrative of functionality to manage content 112(c), where “c” can be any integer from one to “C”. For example, the content manager module 110(m) may be executed to packetize the content 112(c) for distribution over an Internet, encrypt the content 112(c), compress the content 112(c), assign the content 112(c) to particular channels, provide video-on-demand functionality such as “trick modes”, and so on.

The clients 104(1)-104(N) are illustrated as including respective communication modules 114(1)-114(N) that are representative of functionality to manage content by the clients 104(1)-104(N). For example, the communication modules 114(1)-114(N) may be implemented to select (e.g. purchase from the content provider 102(m)), decrypt and/or decompress content 112(c) received from the content provider 102(m). The communication modules 114(1)-114(N) may also be utilized to interact with content 112(c) that may be time shifted as output, such as through one or more command modes that include a pause, fast forward, rewind and so on such as in a digital video recorder, network digital video recorder or video on demand example.

The clients 104(1)-104(N) are also illustrated as including respective commentary modules 116(1)-116(N) that are representative of functionality of the clients 104(1)-104(N) to interact with commentaries. For example, commentary module 116(1) may be executed by client 104(1) to form a commentary during output of content 112(c) as it is received from the content provider 102(m) in real time. The commentary may take a variety of forms, such as text that is output in conjunction with the content, audio, and so on.

The commentary module 116(1) may also be executed to cause the commentary to be communicated such that other clients (e.g., client 104(N)) may interact with the commentary. For example, the commentary service 106 is illustrated as included a commentary manager module 118 that is representative of functionality to manage collection and/or distribution of one or more commentaries 120(k) (where “k” can be any integer from one to “K”) to the clients 104(1)-104(N). The commentary service 106 may be configured in a variety of ways, such as a standalone web service, incorporated as a part of the content provider 102(m), and so on, further discussion of which may be found in relation to the following figure.

The commentary 120(k) may be made available at several different times. For example, during a live television broadcast client 104(N) may subscribe to the commentary output by client 104(1) through the commentary service 106. In another example, if the content 112(c) is in video-on-demand storage, the commentary 120(k) may be output while watching the video-on-demand and synchronized for use of the command modes previously described. In a further example, content recorded locally on the client 104(N) (e.g., when the client 104(N) incorporated digital video recorder (DVR) functionality) is also recorded with the commentary 120(k), either together or separately and subsequent “spliced back” over originally recorded audio on playback of the recording. In yet another example, a rebroadcast of the content 112(c) may also include the commentary 120(k). A variety of other examples are also contemplated.

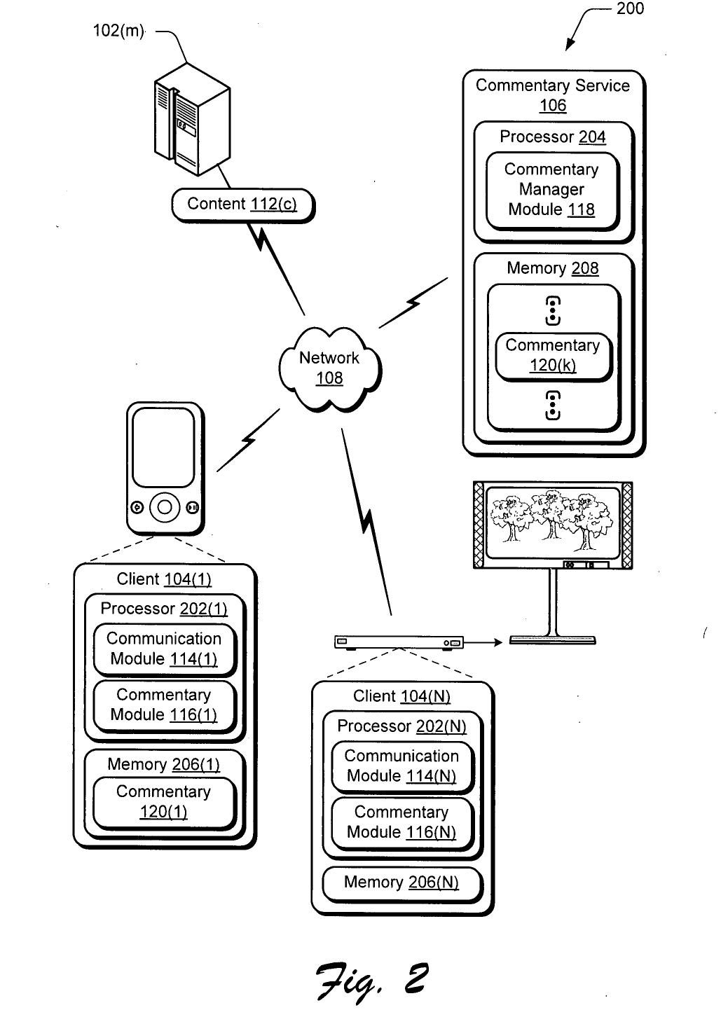

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor. The program code can be stored in one or more computer readable media, further description of which may be found in relation to FIG. 2. The features of the content commentary techniques described below are platform-independent, meaning that the techniques may be implemented on a variety of commercial computing platforms having a variety of processors.

FIG. 2 is an illustration of a system 200 in an exemplary implementation showing the clients 104(1)-104(N) and the commentary service 106 of FIG. 1 in greater detail. The clients 104(1)-104(N) are illustrated as client devices and the commentary service 106 is illustrated as also being implemented by a device, each having a respective processor 202(1)-202(N), 204 and respective memory 206(1)-206(N), 208.

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 206(1)-206(N), 208 is shown, respectively, for the clients 104(1)-104(N) and the commentary service 106, a wide variety of types and combinations of memory may be employed, such as random access memory (RAM), hard disk memory, removable medium memory, and other types of computer-readable media.

As previously described, the commentary module 116(1) is representative of functionality to make a commentary 120(1), which is illustrated as stored in memory 206(1) in FIG. 2. The commentary 120(1) may then be made available to another client 104(N) in a variety of ways, such as through direct communication (e.g., via email) or indirect communication via the commentary service 106.

FIG. 3 depicts an exemplary implementation 300 of a user interface 302 output on a display device 304 of a client 104(N) to locate one of a plurality of commentaries. The displayed user interface 302 is accessed through a browser 306 and is illustrated as including search 308 functionality. For example, a user may enter a content title to locate commentaries 120(k) for the described content, information regarding the content (an example of which is illustrated as “actor”), an author of a desired commentary, and so on. Thus, the client 104(N) in this example may locate a commentary 120(k) by describing the content 112(c) and/or client 104(1) that originated the commentary 120(k). A variety of other examples are also contemplated.

Returning now to FIG. 2, the system 200 may also incorporate a variety of techniques to collect revenue through use of the content commentaries. For example, the commentary modules 116(1)-116(N) may be made available (e.g., from the commentary service 106 or the content provider 102(m)) as a kit for a fee, such as to purchase the modules outright, pay for a subscription to use the modules, and so on.

In another example, the commentary service 106 may also incorporate techniques to collect revenue, such as to provide access to commentaries 120(k) for a fee (e.g., a fee collect per commentary 120(k) purchased, flat rate, subscription based, and so on), include advertisements in a user interface output to select the commentaries 120(k), and so on. In an implementation, the user that originated the commentary 120(k) (e.g., client 104(1)) may be given a portion of the revenue collected for use of the commentary 120(k), a variety of other examples are also contemplated, further discussion of which may be found in relation to the following procedures.

Exemplary Procedures

The following discussion describes commentary techniques that may be implemented utilizing the previously described systems and devices. Aspects of each of the procedures may be implemented in hardware, firmware, or software, or a combination thereof. The procedures are shown as a set of blocks that specify operations to be performed by one or more devices and are not necessarily limited to the orders shown for performing the operations by the respective blocks. In portions of the following discussion, reference will be made to the environment 100 of FIG. 1, the system 200 of FIG. 2 and/or the user interface 302 of FIG. 3.

FIG. 4 depicts a procedure 400 in an exemplary implementation in which a commentary is made by a client and is made available to another client to output in conjunction with content. An ability to utilize a module is purchased that is executable to form a commentary (block 402). For example, the client 104(1) may purchase the commentary module 116(1) on a computer-readable medium and install it on the client 104(1), may download the commentary module 116(1) (e.g., from the commentary service 106)), may access the commentary module 116(1) when being executed on another device (e.g., by the commentary service 106 itself), and so on. Further, the purchase may be performed in a variety of ways, such as for a onetime fee, on a subscription basis, and so on.

A commentary is made, at a client during an output of content, to be output concurrently with a subsequent output of the content (block 404). First, the commentary may take a wide variety of forms. For example, the commentary may be provided in “real time” as the content is output, such as through spoken audio, textual inputs, and so on. Secondly, the commentary may be configured in a variety of ways, such as an overlay displayed over video of the content, a “ticker” display across a screen, “pop-up” windows that include trivia, and so on.

A communication is formed that includes the commentary to be communicated over a network such that the commentary is available to be output at another client concurrently with an output of the content (block 406). The communication, for instance, may be an email that is communicated from client 104(1) that made the commentary 120(1) to client 104(N). In another instance, the communication is a unicast to transmit the commentary 120(1) to the commentary service 106 for distribution by the commentary service 106, such as through use of a multicast. A variety of other instances are also contemplated.

Feedback is received at the client describing use of the commentary by one or more other clients (block 408). For example, the feedback may be monetary in nature (e.g., revenue) that is collected from other clients (e.g., client 104(N)) that pay to access the commentary 120(k) made by the client 104(1). The feedback may also include a variety of other information, such as amount of times accessed, popularity rank, and so on. Additionally, this feedback may be provided in a variety of ways, such as from the commentary service 106, from the commentary module 116(N) of the other client 104(N) through periodic uploads, and so forth. Thus, a variety of commentaries may be formed in a variety of ways to collect revenue using a variety of techniques. These commentaries may then be provided in a variety of ways, such as through use of a commentary service 106, further discussion of which may be found in relation to the following figure.

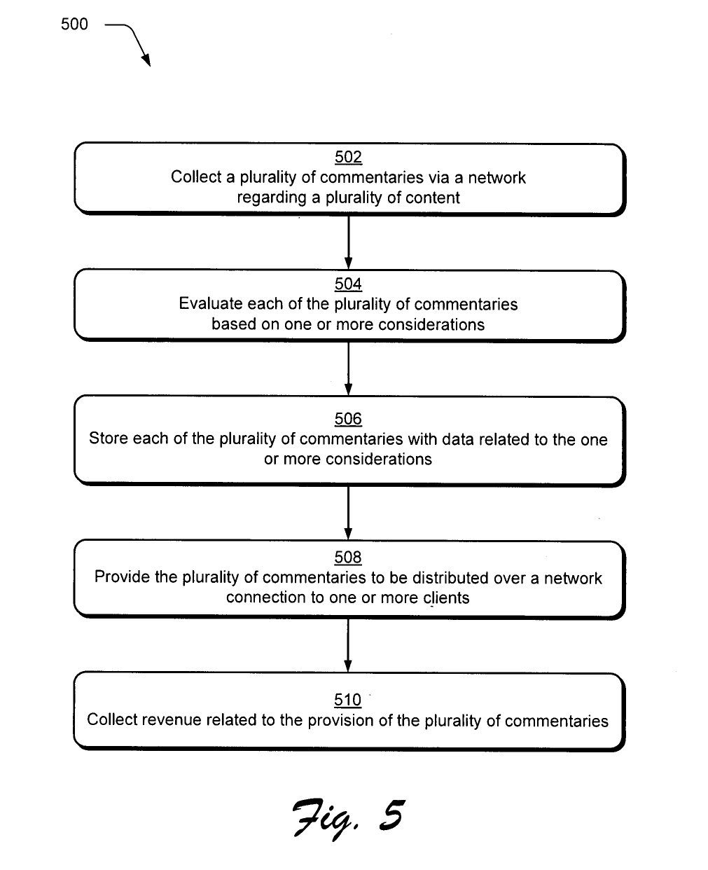

FIG. 5 depicts a procedure 500 in an exemplary implementation in which a commentary service collects commentaries and provides the commentaries for distribution over a network to clients. A plurality of commentaries is collected via a network regarding a plurality of content (block 502). The commentaries 120(k), for instance, may be collected from the clients 104(1)-104(N) through execution of respective commentary modules 116(1)-116(N). As previously described, the commentaries 120(k) may assume a variety of configurations, such as text, a video overlay, an audio output, and so on.

Each of the plurality of commentaries is evaluated based on one or more considerations (block 504). For example, the commentary service 106 may provide “editorial control” of the commentaries 120(k) for content, such as to screen possibly offensive material, unwanted advertisements, and so on. Further this evaluation may also be performed to categorize and arrange access to the commentaries based on the considerations, such as popularity, by related content, by rating assigned to the commentary 120(k) (e.g., by other clients and/or the commentary service 106 itself), and so on. Each of the plurality of commentaries are stored with data related to the one or more considerations (block 506), such as to include the star rating, an indication of a respective category, and so forth.

The plurality of commentaries is then provided to be distributed over a network connection to one or more clients (block 508). For example, the client 104(N) may interact with the user interface 302 of FIG. 3 to search for a particular commentary of interest, such as to provide data related to the corresponding content, data related to an author of the commentary, and so on.

Revenue may also be collected that is related to the provision of the plurality of commentaries (block 510). The commentary service 106 when implemented via a website, for instance, may collect money from one or more advertisements output in the user interface 302 of FIG. 3. The commentary service 106 may also collect revenue from the client 104(N) that accesses the commentary 120(k), such as via a “pay per use” model, a subscription based model and so on. Further this revenue may be “shared” with an author of the commentary 120(k), such as per use, based on popularity ranking, and so forth. A variety of other examples are also contemplated. Through provision of the plurality of commentaries, client 104(N) may have access to a wide range of other commentaries that exist “outside” of the content 112(c) itself, further discussion of which may be found in relation to the following figure.

FIG. 6 depicts a procedure 600 in an exemplary implementation in which a commentary is purchased and output in conjunction with content. A module is purchased to output a commentary in conjunction with content (block 602). Client 104(N), for instance, may access a website provided by the commentary service 106 to obtain the module. In another instance, the client 104(N) may purchase the module on a computer-readable medium, e.g., from a traditional “bricks and mortar” store. A variety of other instances are also contemplated.

A variety of other revenue producing techniques of the commentary service 106 may also be encountered by the client 104(N). The client 104(N), for example, may view one or more advertisements at a website that exposes a plurality of commentaries for purchase (block 604). The client 104(N), through use of the search functionality of FIG. 3, may also locate one or more commentaries of interest and then purchase conditional access rights to output the one or more of the commentaries (block 606). A variety of other examples are also contemplated.

The commentaries may then be provided to the client 104(N) in a variety of ways. For example, the one or more commentaries may streamed in parallel separately from the content (block 608), such as through separate streams within a transport stream. A variety of other examples are also contemplated, such as through storage on a computer-readable medium, dedicated download without the content, and so on. For instance, when the client 104(N) is configured to include digital video recorder functionality, the commentary 120(k) and the content 112(c) may be stored.

Through transport separate from the content, the client 104(N) is able to switch to another commentary available via another stream (block 610). For example, a user interface may be output such that the client 104(N) may select between commentaries during output of the content 112(c), such as from the commentary service 106. Although separate, output of the commentary may be synchronized with the content during implementation of one or more command modes (block 612), such as when the content 112(c) is provided via a video-on-demand store, locally in a digital video recorder example, and so on.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
making a commentary, at a client during an output of content, to be output concurrently with a subsequent output of the content; and
forming a communication that includes the commentary to be communicated over a network such that the commentary is available to be output at another client.

2. A method as described in claim 1, wherein the forming of the commentary is performed in real time during the output of the content.

3. A method as described in claim 1, wherein the commentary is configured as audio.

4. A method as described in claim 1, wherein the commentary includes one or more visual components to be output with the content that includes video.

5. A method as described in claim 4, wherein at least one of the visual components is configured as an overlay.

6. A method as described in claim 1, wherein the commentary is configured to be separate from the content such that the commentary is suitable to be communicated without the content.

7. A method as described in claim 1, wherein the commentary is configured to be streamed in a transport stream separately from a stream used to stream the content to the other client.

8. A method as described in claim 1, further comprising purchasing an ability to utilize a module that is executable on the client to perform the making and the forming.

9. A method as described in claim 1, further comprising receiving feedback at the client describing use of the commentary by one or more other clients.

10. A system comprising one or more modules to:
collect a plurality of commentaries via a network regarding a plurality of content; and
provide the plurality of commentaries to be distributed over a network connection to one or more clients.

11. A system as described in claim 10, wherein:
the network includes an Internet; and
the plurality of commentaries are accessible via a browser.

12. A system as described in claim 10, wherein the plurality of commentaries are provided via a user interface that includes search functionality to locate one or more said commentaries of interest.

13. A system as described in claim 10, wherein the plurality of commentaries are provided via a user interface that includes functionality to indicate a rating assigned to one or more said commentaries.

14. A system as described in claim 10, wherein the plurality of commentaries are provided via a user interface that includes functionality to indicate popularity of respective said commentaries.

15. A system as described in claim 10, wherein the plurality of commentaries are configured as audio, audio and video, text or trivia.

16. A system as described in claim 10, wherein the one or more modules are further configured to implement one or more techniques to collect revenue.

17. A system as described in claim 10, wherein the one or more techniques include output of advertisements in the user interface or collection of revenue to access one or more said commentaries.

18. A client comprising one or more modules that are executable to select one of a plurality of commentaries over a network connection to be output concurrently with content that includes video, wherein the selected commentary is configured to be streamed in parallel separately from the content.

19. A client as described in claim 18, wherein:
the one or more modules provide one or more control functions to time shift an output of the content and the selected commentary; and
the one or more control functions include rewind, fast forward and pause.

20. A client as described in claim 18, wherein the one or more modules are purchased via a network.
